(19) United States
(12) Patent Application Publication
(10) Pub. No.: US 2009/0103726 A1
(43) Pub. Date: Apr. 23, 2009

(54) Dual-mode variable key length cryptography system

(76) Inventor: Nabeel Ahmed, Bangalore (IN)

Correspondence Address: MCCORMICK, PAULDING & HUBER LLP, 185 ASYLUM STREET, CITY PLACE II, HARTFORD, CT, 06103, US

(21) Appl. No.: 11/975,308

(22) Filed: Oct. 18, 2007

(51) Int. Cl. H04L 9/26

(52) U.S. Cl. 380/46

(57) ABSTRACT

In a cryptography system, client and server terminals each generate a private key constituting a randomized compilation of dynamic system parameters. Public keys are then generated based on the private keys, exchanged between the terminals, and used to generate a shared secret. Key stream generators generate a randomized key stream at each terminal using the shared secret, based on self-generating primitive polynomials. Key length is user selected, and may be modified during an ongoing encryption session. The generator includes a plurality of linear feedback shift registers whose lengths are self-configuring based on the user-specified key length. The registers are interconnected so that their output, namely, the key stream, is non-linear and random. Data is converted to binary form and encrypted by XOR'ing the binary-format data with the key stream. The system may be used in both a static secure transfer mode and a dynamic secure real time transfer mode.

### FIELD OF THE INVENTION

The present invention relates to cryptography and, more particularly, to public key cryptography systems with non-linear, e.g., pseudo-random, key generators.

### BACKGROUND OF THE INVENTION

Cryptography techniques have been widely used for transmitting data over networks to provide information security. Several different techniques and algorithms for encrypting information have been proposed, and many of these techniques are currently being widely used in the industry for encryption. Encryption techniques can be classified either as symmetric key encryption or as public key encryption (asymmetric encryption). The main criteria for selecting a particular technique and algorithm for encryption are the level of security provided by the technique, overall performance, and ease of implementation.

Public key cryptography allows users to communicate securely without having prior access to a shared secret key or code. This is done using a pair of cryptographic keys, called a “private key” and a “public key,” which are mathematically related. For securely transmitting a data file, for example from a server terminal to a client terminal, the client terminal generates a public key and a private key, according to a predetermined algorithm. The client terminal transmits the public key to the server terminal, but not the private key. The server terminal uses the public key to encode the data file, which is then transmitted to the client terminal as cipher text, that is, as encoded data. However, although the public key is used to encrypt the data, the private key is required to decrypt the data. The public and private keys are related in such a way that only the public key can be used to encrypt messages, and only the corresponding private key can be used to decrypt them. Moreover, it is difficult (if not virtually impossible) to generate the private key based solely on the public key.

More specifically, in a public key algorithm, the public key defines an encryption transformation Eₑ, while the private key defines the associated decryption transformation D_{d}. A server terminal wishing to send a message “m” to a client terminal obtains an authentic copy of the client terminal's public key “e,” uses the encryption transformation to obtain the cipher text “c”=Eₑ(m), and transmits c to the client terminal. To decrypt c, the client terminal applies the decryption transformation to obtain the original message, m=D_{d}(c).

Because the transfer of a shared secret key is not required, public key encryption is especially useful for data transmission over public networks such as the Internet or other IP-based networks. However, because the public and private keys are mathematically related, it is possible that some relation between the keys in a key pair, or a weakness in an algorithm's operation, could be found which would allow decryption without either key, or using only the public key. As computers become faster and more powerful, chances are increased that a public key algorithm may be defeated using methods that capitalize on computational “brute force.” Additionally, if an existing public key encryption algorithm is defeated, new algorithms are required for the secure transfer of data.

### SUMMARY OF THE INVENTION

According to an embodiment of the present invention, a method and system for encrypting data involves generating a key stream, e.g., a stream of bits used for encryption and/or decryption purposes. As the key stream is generated, it is used to encrypt the data. The key stream is based at least in part on a private key. That is, the key stream is directly or indirectly mathematically generated from the private key and possibly other keys. The private key is a randomized compilation of at least one dynamic system parameter of the terminal on which the private key is generated. By “dynamic system parameter,” it is meant information relating to the terminal's operation that varies in time and that may be expressed in binary form, e.g., the number of processes running, process and group identifiers, CPU utilization, timer information, and the amount of information in RAM, buffers, or other memory. By “randomized,” it is meant that the compilation is randomly or pseudo-randomly ordered, and/or that the private key is randomly or pseudo-randomly generated using the compilation of dynamic system parameters as a seed value or “starting point.”

In another embodiment, the system includes a random/pseudo-random number generation mechanism for generating random/pseudo-random numbers, e.g., the private key, based on readily available system parameters. As such, the random number generator is efficient (with respect to performance and randomization) and requires no complex mathematical operations for the generation of random numbers of any bit length.

In another embodiment, a shared secret key is generated at a first terminal, e.g., at a server terminal or other computer or processor unit. The shared secret key is mathematically generated based on the server terminal's private key and on a public key received from a second terminal, e.g., a client terminal. Data for transmission to the client terminal is encrypted based on the shared secret key. That is, the shared secret key may be used directly to encrypt the data, or it may be used to generate the key stream for encrypting the data.

In another embodiment, both the server terminal and the client terminal generate a private key. Each then generates a public key based on the private key, that is, the public key is mathematically related to the private key. The server and client terminals exchange public keys, which are used in conjunction with their respective private keys to generate the shared secret key. The server terminal encrypts data using the shared secret key (or a key stream generated based on the shared secret key) and transmits the data to the client terminal, which uses the shared secret key (or the key stream) to decrypt the encrypted data.

In another embodiment, a key stream generator is provided at each terminal for generating the key stream based on the shared secret key. For encoding data at the server terminal, the key stream is XOR'ed with the data in a bitwise manner (e.g., the bits are subjected to a logic XOR operation), and for decoding the encoded data at the client terminal, the encoded data is again XOR'ed with the key stream. The key stream is at least pseudo-randomly generated based on self-generating primitive polynomials in the key stream generator. By “at least” pseudo-random, it is meant random, pseudo-random, or periodically random or pseudo-random, e.g., the key stream is randomly or pseudo-randomly generated but eventually repeats. (Typically, the key stream will only repeat with a very high periodicity, such that the probability of repetition is almost impossible within the same session of data transfer. Moreover, the key stream generators are randomized and synchronized between client and server every session, thereby making it virtually impossible for the key stream to repeat.)

As should be appreciated, a single key is not used throughout the entire session of information transfer, that is, throughout the session multiple random/pseudo-random keys are generated and used at different stages of the session. Additionally, the key length can be changed within the session or at the start of every session. The system is thereby made more secure and robust.

In another embodiment, the key stream generator comprises a plurality of interconnected linear feedback shift registers (LFSR's), e.g., there may be three LFSR's, which are synchronized based on LFSR clocking. The shared secret key is used to seed the LFSR's, whose lengths are self-configuring based on the key length specified by the user or as otherwise established in the system. The LFSR's are tapped, for clocking and feedback purposes, according to primitive polynomials that are generated based at least partially on the selected key length (e.g., to provide maximum periodicity for the key stream, and for efficient key stream generation). Key lengths may be kept in multiples of 128 for optimal performance.

In another embodiment, the system is configured for user selection of key length for the encryption/decryption process. Thus, the user need not switch to other cryptography systems due to insufficient key length. For example, the user can choose a shorter-length key (e.g., a 32 or 128 bit key length) for higher performance in terms of CPU and memory usage, or a longer-length key (e.g., 4096 bit key length) for higher security. Typically, an initial key length is selected at the start of an encryption session. Thereafter, the user can modify the key length concurrent with data encryption, that is, the key length is changed after data encryption has commenced but prior to the encryption operation ending.

In another embodiment, the encryption system and method can be used for static secure data transfer or for dynamic secure real time data transfer.

In another embodiment, the data to be encrypted is first converted into binary form, thereby allowing data in any format (e.g., video, audio, text, and the like) to be encrypted and decrypted according to the present invention.

### BRIEF DESCRIPTION OF THE DRAWINGS

The present invention will be better understood from reading the following description of non-limiting embodiments, with reference to the attached drawings, wherein below:

FIG. 1A is a schematic diagram of a variable key-length cryptography system according to an embodiment of the present invention;

FIG. 1B is a schematic diagram of a communication system on which the cryptography system may be implemented;

FIG. 2 is a schematic diagram showing operation of the cryptography system in FIG. 1;

FIG. 3 is a flow chart showing operation of the cryptography system on a client terminal;

FIG. 4 is a flow chart showing operation of the cryptography system on a server terminal;

FIG. 5 is a schematic diagram of a key stream generator portion of the system;

FIGS. 6 and 7 are schematic diagrams showing encrypting and decrypting operations carried out on the server and client terminals, respectively; and

FIGS. 8A and 8B are schematic diagrams of a private key generator portion of the system.

### DETAILED DESCRIPTION

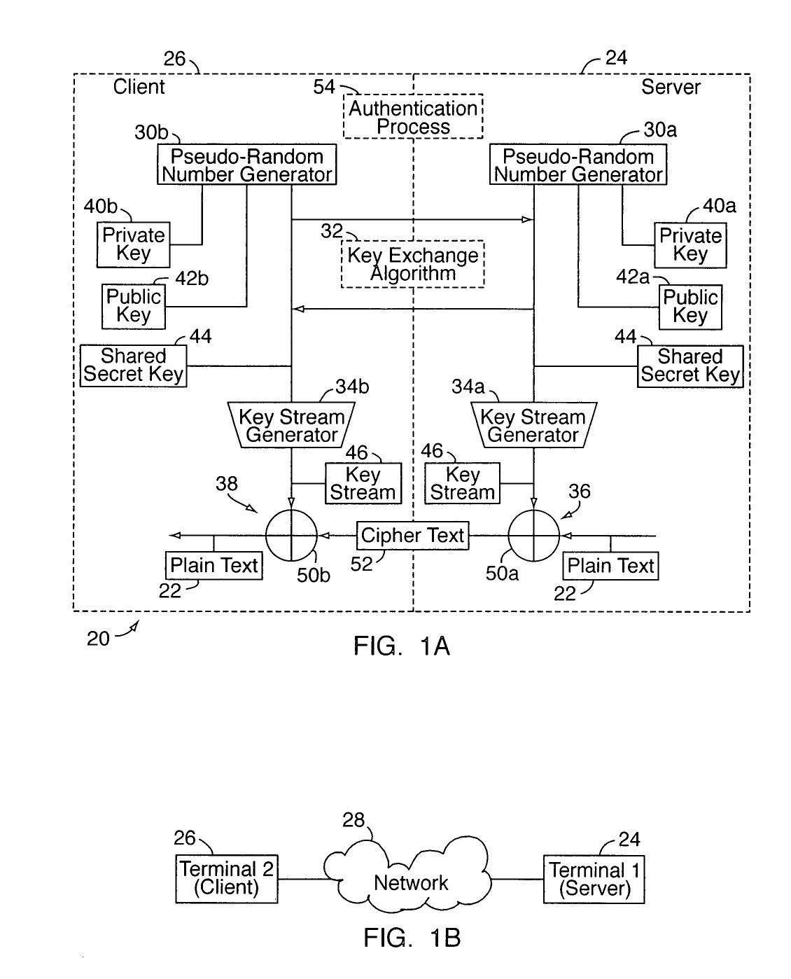

With reference to FIGS. 1A-8B, an embodiment of the present invention relates to a dual-mode, variable key length cryptography system 20 for encrypting and decrypting data 22, e.g., “plain text” data. The system 20 is useable in two different modes: a static secure transfer mode and a dynamic secure real time transfer mode. In the static transfer mode, the system 20 is used to transmit a static file (of any format) containing the data 22. In this mode, the system may be implemented as a stand alone software or hardware-based module, or as an adjunct or “add on” function/service for use with an existing system. In the dynamic transfer mode, the system 20 is used for encrypting data in the case where the file/data being transmitted may be dynamically modified by some external source, and the system expects real time transfer of the file (again, in any format). In this mode, the system 20 will typically be implemented as an adjunct module for use with an existing non-secure data transfer/communication system where the data being transmitted may be dynamically modified. As its name suggests, the variable key length cryptography system may be configured to allow a user to change the encryption/decryption key length, both at the start of any particular session and during an ongoing session. In other words, the system 20 may provide an option for varying the key length even as data is being encrypted and decrypted.

The cryptography system 20 may be implemented in the context of data transfer from one terminal to another. By “terminal,” it is meant a computer or other processor-based unit such as server and desktop computers, electronic devices including music and video players, digital still and video cameras, wireless units including mobile phones, wireless PDA's, wireless devices with high-speed data transfer capabilities, such as those compliant with “3-G” or “4-G” standards, “WiFi”-equipped computers, or the like. For example, with reference to FIG. 1B, the system 20 may be used for encrypting data for transfer from a server terminal 24 to a client terminal 26 over a communication network 28 such as the Internet or other packet data network, a wireless network, a public switched telephone network, a local area network, or any combination thereof. The system 20 will be primarily described herein in the context of server terminal to client terminal communications; however, as should be appreciated, the system 20 is applicable for use in any situation where it is desired to transmit data from one location to another in a secure manner. The cryptography system 20 is deployed in place on each terminal 24, 26 where it is desired to transmit and/or receive data encrypted according to the cryptography method carried out by the system.

From a functional, system-level perspective, the variable key length cryptography system 20 includes a pseudo-random number generator 30a, 30b, a key exchange algorithm 32, a key stream generator 34a, 34b, an encryption section 36, and a decryption section 38. In overview, the pseudo-random number generator 30a, 30b on each terminal 24, 26 generates a private key 40a, 40b and a public key 42a, 42b. Each private key 40a, 40b is a string of bits whose length (e.g., 32 bits to 4096 bits) may be selected by the user. The private key 40a of the server terminal may be a randomized compilation of one or more dynamic system parameters of the server terminal, and the private key 40b of the client terminal may be a randomized compilation of one or more dynamic system parameters of the client terminal. The dynamic system parameters may include the number of processes running on the terminal or terminal CPU, process and group identifiers, CPU utilization, timer information, and the amount of information in RAM, buffers, or other memory. A compilation of this nature in effect provides a random private key of a selected or otherwise designated length. The public keys 42a, 42b are then mathematically generated as a function of the private keys 40a, 40b, respectively, as further explained below. The server and client terminals 24, 26 exchange public keys 42a, 42b over the network 28 while maintaining the private keys in secret, e.g., the private keys are not transmitted over the network 28. Using the public and private keys, each terminal calculates the same shared secret key 44 (again, a string of bits). That is, due to the mathematical relationship between the keys, the shared secret key 44 is a function of both (i) the client private key 40b and server public key 42a, and (ii) the client public key 42b and the server private key 40a. Knowing either or both public keys alone, the shared secret cannot be generated. Instead, a private key and an “opposite” public key (e.g., a public key from the other terminal) are required for generating the shared secret key 44.

The key stream generator 34a on the server terminal 24 uses the shared secret key 44 as the basis for generating a random or pseudo-random key stream 46, e.g., another sequence of bits. The key stream 46 is used for encrypting and decrypting data. To generate the key stream 46, three interconnected linear feedback shift registers (LFSR's) 48a-48c are seeded with the shared secret key 44. The bit lengths of the LFSR's are self-configuring based on the length of the shared secret key 44, which corresponds to the length of the private key specified by the user or as otherwise established in the system. Additionally, the LFSR's 48a-48c are tapped, for clocking and feedback purposes, according to a primitive polynomial that is generated based at least in part on the selected key length, to provide maximum periodicity for the key stream 46. For encoding data 22 at the server terminal 24, the key stream 46 is XOR'ed with the data 22 in a bitwise manner, e.g., the bits are subjected to a logic XOR operation using an XOR logic gate or function 50a, resulting in a set of encrypted data (“cipher text”) 52. The cipher text 52 is transmitted to the server terminal 26 over the network 28, in a standard manner. For decrypting the cipher text 52, the cipher text 52 is XOR'ed in a bitwise manner with the key stream 46, which is generated at a trusted client terminal 26 by the key stream generator 34b. This may be done using an XOR logic gate or function 50b. As should be appreciated, according to a standard logic identity:

(plain text)XOR(key stream)=cipher text

(cipher text)XOR(key stream)=plain text

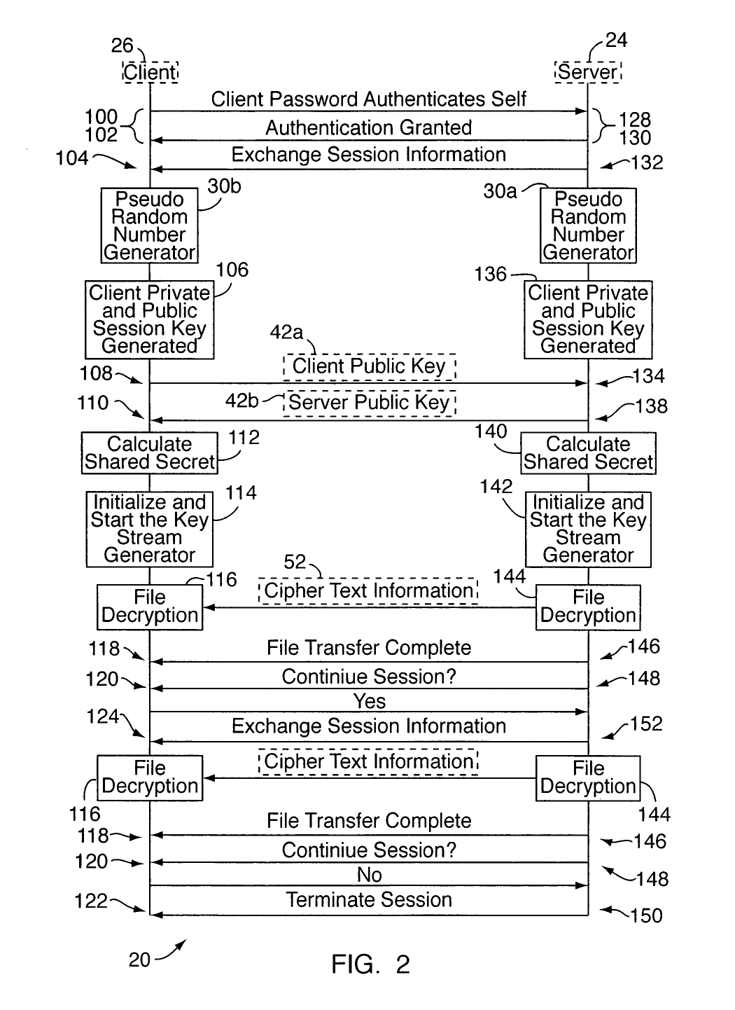

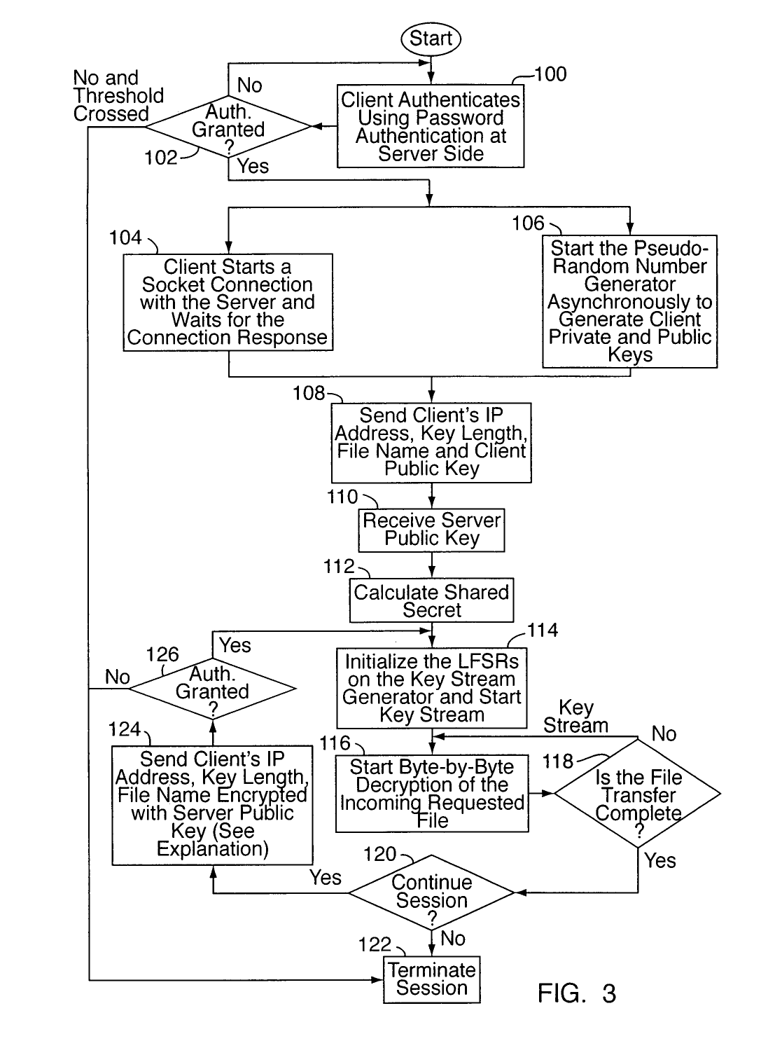

Operation of an embodiment of the cryptography system 20 will now be described in more detail with reference to FIGS. 1A-4. From the client side 26, with reference to FIGS. 2 and 3, at Step 100 the client terminal 26 authenticates to the server terminal 24 using a password authentication process, e.g., the client terminal transmits password information to the server terminal. (This is shown graphically as an “authentication process” 54 in FIG. 1A.) At Step 102, the client terminal waits for the server terminal 24 to verify the password information and to authenticate the client terminal 26 for secure transfer of files. The process may include a threshold for terminating the session if authentication fails a certain number of times. It should be noted that the authentication process 54 is optional. In particular, in some situations it may not be desirable to have password authentication due to password aging. In such a case, as soon as the client terminal 26 requests a secure transfer of data from the server terminal, the pseudo-random generator 30b is started asynchronously.

After authentication (if used), the client terminal 26 starts a socket connection with the server terminal 24 and waits for a connection response, as at Step 104. At or around that time, the client terminal 26 initiates activation of the pseudo-random generator 30b asynchronously to generate the client private key 40b and the client public key 42b, as at Step 106. The length of these keys may be based on a user selected key length for encryption/decryption. Additionally, there may be a default key length such as 128 bits. More information on private and public key generation is given below. At Step 108, the client terminal 26 transmits the client's IP address, the key length desired for data encryption/decryption, the file name to be sent securely over the network (e.g., the name of the file containing the data 22 that the client is requesting from the server), and the client's public key 42b. Alternatively, the session information (such as client's IP address, key length, and file name) can be encrypted with the client's public key. (As should be appreciated, the IP address will only be transmitted if the network 28 is an IP network or includes an IP network portion.) At Step 110, the client terminal 26 receives the server terminal's public key 42a. At Step 112, the client terminal 26 calculates the shared secret key 44. (The shared secret key 44 is calculated exactly the same at both terminals using modular arithmetic operations, as explained further below.) At Step 114, the client terminal initializes the clock-controlled LFSR's 48a-48c in the key stream generator 34b, and starts the key stream generator 34b for generating the key stream 46 based on one or more primitive polynomials (defined in both the client and server terminals), to destroy the linearity of the LFSR's. At Step 116, the key stream 46 generated by the key stream generator 34b is used to decrypt the incoming bytes of the cipher text 52. At Step 118, it is determined if the end of the file (e.g., the end of the string of cipher text) has been reached. If not, the decryption process continues at Step 116. If the end of the cipher text has been reached, then the client terminal 26 chooses whether to continue the session, as at Step 120. If not, the session terminates at Step 122. If so, at Step 124 the client terminal 26 provides information as at Step 108, to the extent required. For example, if the client terminal's IP address and the key length are the same as that of the present session, then all that is required is the name of the file for transfer, which is sent to the server terminal at Step 124. The client may be re-authenticated, as at Step 126, if desired. Subsequently, the process continues at Step 116 (e.g., the same keys are used to encrypt and decrypt the second file). If the client terminal's IP address has changed, or if the key length has changed, then the client's IP address, the key length, and the file name are sent to the server terminal at Step 124. Subsequently, the process continues at Step 114, including (optionally) the authentication process 126.

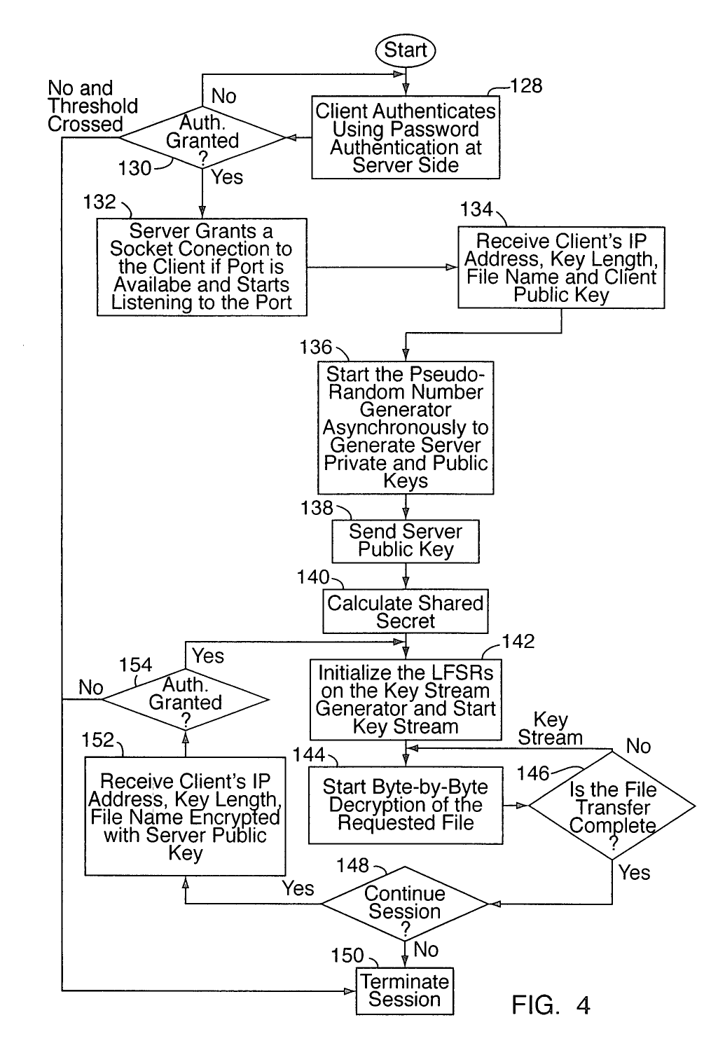

From the side of the server terminal 24, with reference to FIGS. 2 and 4, at Step 128 the client terminal 26 authenticates to the server 24 according to the password authentication process 54. At Step 130 the server terminal 24 verifies whether the password information is correct, and, if so, authenticates the client for secure transfer of files. (Again, the authentication process is optional.) At Step 132, the server terminal 24 grants a socket connection to the client terminal 26 if a port is available, and commences monitoring of the port. At Step 134, the server terminal receives the client terminal's IP address, the desired key length, the name of the file to be transmitted securely over the network 28, and the client terminal's public key 42b. At Step 136, the server terminal initiates operation of the pseudo-random number generator 30a to generate the server terminal's private key 40a and public key 42a, based on the requested key length received from the client terminal. At Step 138, the server terminal transmits its public key 42a to the client terminal. At Step 140, the server terminal generates the shared secret key 44. The shared secret key 44 is the same on both terminals. At Step 142, the clock-controlled LFSR's in the key stream generator 34a are initialized, and the key stream 46 is generated. At Step 144, the key stream 46 is used to encrypt the data 22, which is transmitted over the network to the client terminal. This continues until the end of the file is reached, as determined at Step 146. Once the end of the file has been reached, if client terminal chooses not to continue the session (Step 148), then the session terminates at Step 150. If the client terminal chooses to continue, the process continues at Steps 152 and 154, which are similar to steps 124 and 126 in FIG. 3.

The dual-mode variable length cryptography system 20 provides for the secure transfer of data with limited buffering, and can be readily implemented using both hardware and software without compromising on efficiency. The system also utilizes randomized keys of variable length for secure and authentic transfer of information. The individual components of the system 20 will now be described in greater detail.

The pseudo-random number generator 30a, 30b (in place on each terminal) uses dynamic system parameters of the terminals to randomly generate the private keys 40a, 40b, which are subsequently used to generate the public keys 42a, 42b. In particular, the private key 40a of the server terminal 24 comprises a compilation of one or more of the following dynamic (e.g., changing in time) system parameters of the server terminal: the number of processes running; process and group identifiers; CPU utilization statistics/values; timer information; and/or the amount of information in RAM, buffers, or other memory. The dynamic system parameters, in bit form, are consolidated into a string of bits (the order of the dynamic parameters in the string may vary), which is subsequently randomized. This forms the server terminal private key 40a. (The private key generation process is described in greater detail below with reference to FIGS. 8A and 8B.) The length of the private key 40a may be user selected. For example, the private key may be from 32 bits to 4096 bits long, and there may be a default length such as 128 bits. The client terminal private key 40b is generated in a similar manner using the client terminal's dynamic system parameters.

The purpose of the key exchange algorithm 32 is to generate public keys 42a, 42b that, when combined with the private keys of the opposite terminals, generate the shared secret key 44, as indicated below.

Client side:

client_public_key=f(client_private_key)

shared_secret_key=f(server_public_key,client_private_key)

Server side:

server_public_key=f(server_private_key)

shared_secret_key=f(client_public_key,server_private_key)

Ostensibly, the system 20 is based on a public key algorithm. However, because the private and public keys are used to generate the shared secret key, which is the same at both terminals and is used to encrypt and decrypt data (directly or indirectly), the system 20 can also be thought of as a symmetric key encryption system. In effect, the system is a hybrid cryptography system combining aspects of both public key and symmetric key encryption methodologies.

To arrive at the relationship above (regarding the public keys, private keys, and shared secret key), the key exchange algorithm 32 uses modular arithmetic to generate the public keys and perform the key exchange. For the key exchange algorithm, at the client terminal the pseudo-random number generator 30b is used to generate or select a random or pseudo-random prime number “P.” The prime number P may be, for example, from 32 to 4096 bits in length. Also, P>Xa, where “Xa” is the client private key. Subsequently, values “f (P)” and “Xb” are calculated as follows:

f(P)=(P−1)

Xb=f(P)^{Xa} mod P

Xb is used as the client terminal public key, which is subsequently transmitted to the server terminal.

On the server side, using the same prime number P, the values f (P) and “Yb” are calculated, as indicated below. “Ya” is the server terminal private key (e.g., randomized compilation of server terminal dynamic system parameters), and P>Ya.

f(P)=P−1

Yb=f(P)^{Ya} mod P

Yb is used as the server terminal public key, which is subsequently transmitted to the client terminal. Each terminal 24, 26 subsequently calculates the shared secret key 46. At the client terminal:

shared secret key=(server public key)(client private key)mod P Yb^{Xa} mod P

At the server terminal:

shared secret key=(client public key)(server private key)mod P Xb^{Ya} mod P

The following is a brief proof showing that the shared secret key will always be the same at both terminals 24, 26:

$$Y {b}^{X a} mod P \\ = {( {f ( P )}^{Y a} mod P )}^{X a} mod P \\ = ( {f ( P )}^{YaXa} mod P ) mod P \\ = {( {f ( P )}^{X a} mod P )}^{Y a} mod P \\ = X {b}^{Y a} mod P$$

The prime number P may be originally generated at the client terminal based on user selection of the private key length Xa, such that P>Xa, as noted above. The generated prime number P is then transmitted from the client terminal to the server terminal, possibly in encrypted form as part of the session information or otherwise. Alternatively, the client and server terminals may each include a prime number generation algorithm, wherein the algorithm generates the same prime number given a selected private key length. Since generating long prime numbers can be costly in terms of system resources, however, each terminal may instead be provided with a pre-selected list or table of prime numbers for different private key lengths. When the private key length is selected, the terminals simply cross reference the key length to the list/table for determining the prime number for that key length. Each key length may have a plurality of possible prime numbers, which the terminals cycle through in different sessions, for increasing security. It should be noted that even if the table of prime numbers is exposed, the self-configuring LFSR's 48a-48c will randomize the shared secret key, which cannot be anticipated.

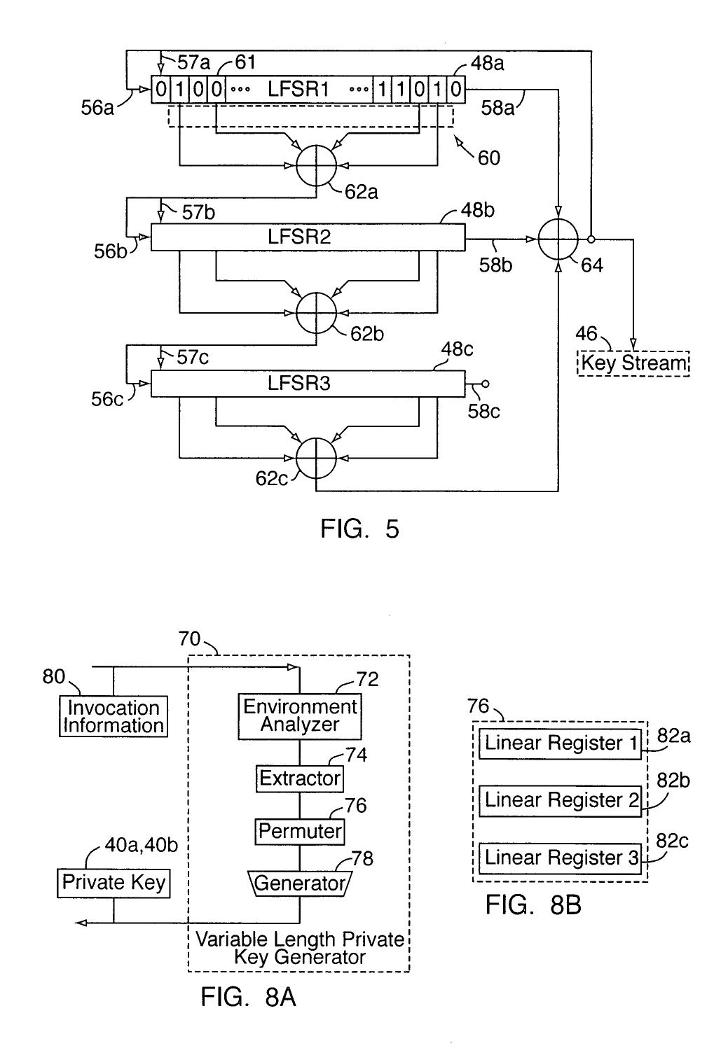

The key stream generators 34a, 34b generate the key stream 46 for encryption and decryption purposes, based on the shared secret key 44. With reference to FIG. 5, each key stream generator 34a, 34b includes a set of three null-initialized LFSR's 48a-48c of variable length “n.” (The total length of all the LFSR's, e.g., 3 n, will typically be at least as long as the maximum allowed key length in the system 20. For example, if the maximum key length is 4096 bits, then 3 n≧4096.) Initially, the LFSR's 48a-48c adjust their lengths based on the length of the shared secret key, e.g., as selected by the user. Additionally, the adjusted length of each LFSR 48a-48c is of prime length (that is, a prime number). Thus, e.g., if the key length is 128 bits then the first LFSR 48a will adjust to 43 bits, the second LFSR 48b will adjust to 43 bits, and the third LFSR 48c will adjust to the left over number of bits at the next largest prime, in this example, 43 bits. After the lengths of the LFSR's are adjusted, the shared secret key is used to initialize the LFSR's. In particular, the 32-4096 bit shared secret key 44 is distributed or divided among the LFSR's 48a-48c, with the bits values of the shared secret key acting as seed values (e.g., initial bit values) for the LFSR's 48a-48c.

A linear feedback shift register is a shift register whose input bit is driven by the exclusive-or (XOR) of various selected bits of the overall shift register value; the exclusive-or (XOR) of the selected bits is a linear function that is applied to the input as linear feedback. In the system 20, the LFSR's 48a-48c are used in a somewhat different manner, wherein the feedback of one LFSR is used to clock a subsequent LFSR. Each of the LFSR's 48a-48c has a feedback input 56a-56c, a clock input 57a-57c, an output 58a-58c, and a plurality of configurable taps 60 connected to various cells 61 in the shift register and to a feedback logic XOR gate 62a-62c. (By “configurable,” it is meant that the taps can be electronically/automatically reconfigured for attachment to different cells in the shift register; such a function can be carried out in software and/or hardware.)

The LFSR's 48a-48c are interconnected as shown in FIG. 5. In particular, the outputs 58a, 58b of the first two registers 48a, 48b are connected to a main output XOR gate 64. For the third register 48c, the feedback output from its XOR gate 62c is connected to the main XOR gate 64. (The output 58c of the third register is not utilized since it would be a linear sequence.) The output of the main XOR gate 64 is connected to the feedback input 56a of the first register 48a. Additionally, the output of the main XOR gate 64 is connected to the clock input 57a for providing an internal feedback clock. The internal feedback clock signal (e.g., the output of the XOR gate 64) will typically be used if the system is implemented by way of software, and may also be used for a hardware implementation. Alternatively, an external clocking signal/line may be attached to the clock input 57a of the first register 48a, for hardware-based implementations of the system 20. In such a case, the output of the main XOR gate 64 would only be connected to the feedback input 56a of the first register 48a. The feedback output from the XOR gate 62a of the first register 48a is used for clocking the second register, with the XOR gate 62a being connected to both the clock input 57b and the feedback input 56b of the second register 48b. Additionally, the feedback output from the XOR gate 62b of the second register 48b is connected to both the clock input 57c and the feedback input 56c of the third register 48c.

The taps 60 for each LFSR 48a-48c are selected according to a generated primitive polynomial. The length of the shared secret key 44 affects the primitive polynomial that is generated, based on the number of bits in the LFSR. This newly generated primitive polynomial in turn affects the clocking of other LFSR's, based on the interconnections between the three LFSR's 48a-48c. To explain further, tapping a feedback register according to a primitive polynomial defines a recurrence relation that can be used to generate random bits. For example, given the primitive polynomial x¹⁰+x³+1 (this polynomial is provided as an example only; an actual polynomial for use in the system would be of higher degree), and with the shared secret key providing the seed values for the register, the 10th, 3rd, and 0th bits of the shift register are tapped, starting from the least significant bit. These values are routed to the XOR gate 62, resulting in a new bit. An “m” bit LFSR can be in any one of 2 m−1 interval states. A primitive polynomial of degree “m” may be used for the tap sequence, to provide maximum periodicity for the randomly generated key stream 46a. Thus, for an m bit LFSR the system generates an m degree primitive polynomial. This may be done using a standard algorithm, or by referencing a lookup table containing primitive polynomials for different degrees/orders. (For example, the 5^{th} order primitive polynomials, in the case where m=5, would be: 1+x²+x⁵, 1+x+x²+x⁵, 1+x³+x⁵, and so on.)

The output of the XOR gate 62a of the first register 48a controls the clocking of the second register 48b. The output of the XOR gate 62b of the second register 48b in turn controls the clocking of the third register 48c. For example, if the output of the XOR gate 62a of the first LFSR 48a is equal to 1, then the second LFSR 48b clocks. The same relation exists between the second and third LFSR's 48b, 48c. (For the first LFSR 48a, in the case where internal feedback clocking is used as shown in FIG. 5, it should be noted that the internal feedback value will clock the first LFSR 48a irrespective of its value.) In effect, the second and third LFSR's 48b, 48c are randomly clocked, with the correspondingly random outputs of the three LFSR's being combined by way of the XOR gate 64. The bit values output from the XOR gate 64 constitute the key stream 46. Again, the key stream 46 is random because it is a function of the LFSR's 48a-48c, which are randomly circulated. To elaborate, each LFSR 48a-48c is rendered non-linear. The first LFSR 48a is made non-linear by routing the output from the main XOR gate 64 to the feedback input 56a and possibly the clock input 57a. The second LFSR 48b is rendered non-liner using selective clocking based on the output of the first LFSR's XOR gate 62a. The third LFSR 48c is made non-linear by feeding the output of the XOR gate 62c to the main XOR gate 64. (If there was a need for an additional LFSR, the third LFSR 48c would be selectively clocked, with its output 58c directed to the main XOR gate 64, and the additional LFSR would be configured in the same manner as the third LFSR 48c as shown in FIG. 5.) In this manner, the LFSR's 48a-48c and the key stream output of the XOR gate 64 are not linear, but rather very random. Thus, as should be appreciated, one of the advantages of the cryptography system 20 is that the key stream 46 is randomly generated based on primitive polynomials in the key stream generators, for encryption and decryption purposes. Moreover, the key length can be changed within the session or at the start of a session. This leads to a more secure and robust cryptography system.

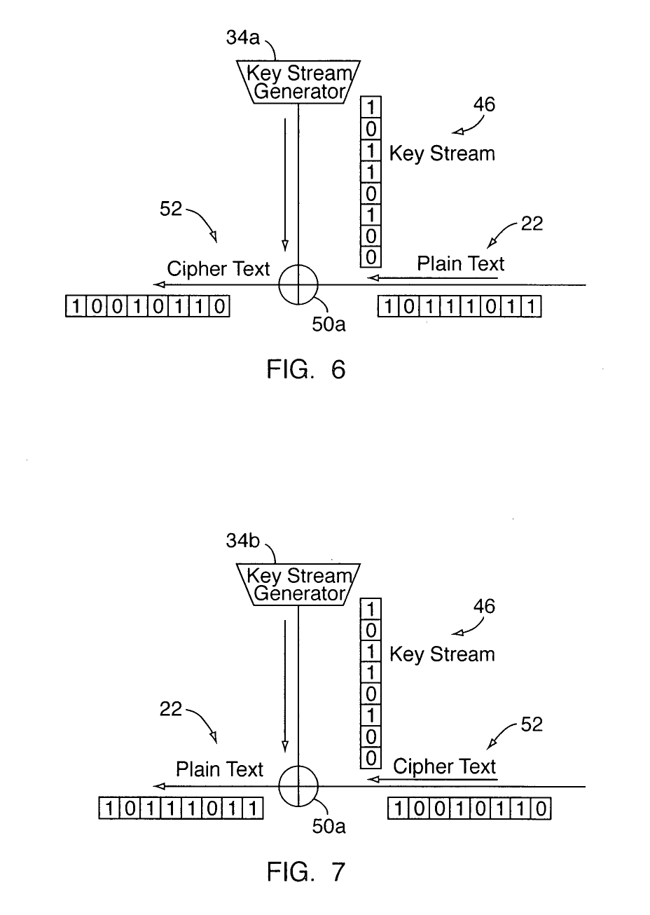

The encryption and decryption process is shown in more detail in FIGS. 6 and 7. For encryption at the server terminal 24, the source data 22 is converted to a binary extract, if needed, e.g., a representation of the data in binary 1 and 0 values, in a standard manner. The server terminal performs a bitwise XOR operation of the binary plaintext data 22 with the key stream 46 generated by the key stream generator 34a. In other words, the bits of the key stream 46 and data 22 are sequentially applied to the inputs of the XOR gate 50a. For each two input bits, this process forms a bit of cipher text 52. For efficiency in software, a byte of plaintext data 22 may be collected in binary mode, with each bit of this byte being respectively XOR'ed with the next eight bits generated from the key stream generator 34a. However, in a hardware implementation, a bit-by-bit encryption can be performed without any performance issues. After encryption, the cipher text 52 is transmitted over the network 28 to the client terminal 26. For decryption, as illustrated in FIG. 7, the client terminal 26 performs a bitwise XOR operation of the cipher text 52 with the key stream 46. (As should be appreciated, the key stream 46 is the same at both terminals 24, 26. This is because both use the shared secret key 44 for seeding the key stream generators 34a, 34b, which are configured the same.) Again, as noted above, (plain text) XOR (key stream)=cipher text, and (cipher text) XOR (key stream)=plain text.

Although not shown in the drawings, the cryptography system 20 will typically include a user interface for allowing a user to select various operational modes of the system. These may include selection of whether to transfer data securely, the name or other identity of the file/data 22 to be transferred, a key length, and the like. The user interface may be an existing user interface of the client and/or server terminal, which is modified by the system 20 for use therewith. For example, the client and server terminals may include a standard communication program allowing for a user to select data files for transfer from the server terminal to the client terminal. In such a case, the system 20 would be interfaced with the existing communication program for allowing a user to securely transfer data, and to select a key length.

As noted above, the pseudo-random number generators 30a, 30b are configured to generate the private keys 40a, 40b based on dynamic system parameters. For this purpose, each pseudo-random number generator 30a, 30b includes a variable length private key generator 70, as shown in FIGS. 8A and 8B. The variable length private key generator 70 generates private keys 40a, 40b of variable lengths in such a way that the probability of key repetition is minimal. Additionally, the private key generation process does not involve any complex mathematical operations that monopolize CPU resources and system memory. The private key generator 70 can be readily implemented using hardware and/or software without compromising on efficiency, and provides randomized keys of variable lengths for the secure transfer of information.

As indicated in FIG. 8A, the private key generator 70 may include an environment analyzer 72, an extractor component 74, a permuter component 76, and a generator component 78. The private key generator 70 commences operation upon receipt of invocation information 80 from elsewhere in the system 20, e.g., from the user interface noted above. The invocation information provides the private key generator 70 with the key length to be generated (e.g., 32 to 4096 bits), the usage mechanism (such as hardware or software), and information for collecting data in the case of implementation in hardware. The environment analyzer's 72 basic function is to detect/identify the operating system of the terminal in question (e.g., client or server terminal), including the version of the operating system used to invoke the private key generator 70. This function is performed only when the cryptography system is implemented as a software-based service/product. If the cryptography system is implemented in hardware, then the environment analyzer 72 will perform a set of different operations, such as detecting the sources of dynamic, readily available data through the hardware interface. For software implementation, for example, the environment analyzer 72 first detects the operating system and version using generic software commands, e.g., generic C functions. Next, the analyzer 72 detects the memory system used by the operating system. Then, the analyzer 72 detects the memory available per application running on the terminal, the memory provided to the application invoking the system 20 (e.g., if the system 20 is implemented for use with a communication application or the like), and the buffer memory availability at that instant of time.

The basic function of the extractor 74 is to collect the dynamic, readily available data and to determine whether a random key of the length specified by the user can be generated. If not, the generator 70 aborts the current operation. Otherwise, the extractor 74 feeds the extracted data to a memory pool used by the permuter 76. The extractor 74 may extract information from one or more of the following sources, as identified by the environment analyzer: the number of processes running; process and group identifiers; CPU utilization; timer information in milliseconds; the amount of information in RAM and buffers; RAM and buffer memory available at that instant of time; and peripheral device usage percent or rate. The extractor 74 stores the collected data into a set of linear registers 82a-82c (see FIG. 8B) of primitive length, based on the key length selected by the user. For example, for a 32-bit key, each register 82a-82c would be 11 bits long.

The basic function of the permuter 76 is to permute the linear registers 82a-82c using primitive polynomials of degree m/2, where “m” is the primitive length of each linear register at hand. These polynomials will change the order in such a way that a similar key pattern will not be generated even if the linear registers 82a-82c have the same information. The linear registers 82a-82c cannot have the same information at two different instants of time, but this hypothetical situation is considered herein for providing a robust algorithm. The operation and interconnection of the registers 82a-82c can be the same as the LFSR's 48a-48c shown in FIG. 5, and in fact the same set of LFSR's can be used for both operations.

The permuter's randomization and efficiency can be tested using the following tests. First, convert the key from decimal to binary. Second, perform the first level of testing using a frequency test. The purpose of this test is to determine whether the number of 0's and 1's in sequence “S” is approximately the same, as would be expected for a random sequence. Let n0 and n1 denote the number of 0's and the number of 1's is a sequence S, respectively. The statistic used is:

X=(n0−n1)²/n

This approximately follows an X² distribution with one degree of freedom if n≧10. Third, perform the second level of testing using the “poker test.” The poker test determines whether the sequence of length “m” each appear approximately the same number of time in sequence S, as would be expected for a random sequence. The statistic used is:

X=(2^{m}/K)*Sum(nᵢ²)−K

This approximately follows a X² distribution with 2^{m}-1 degrees of freedom. Where m is a positive integer such that (n/m)≧5*2^{m} and K=n/m, divide the sequence S into K non-overlapping parts each of length m and let nᵢ be the number of occurrences of the “ith” type of sequence of length m, 1≦i≦2^{m}.

The function of the generator 78 is to encapsulate the key generated by the permuter 80 into packets that can be extracted to get the generated private key 40a, 40b, if such a function is required. For example, applications that use the private key generator 70 as an internal system component would not require any encapsulation mechanism, as the generated private key would be treated as an internal value.

In an additional embodiment of the present invention, the system 20 is configured for handling the situation of a server or client terminal crash. In ongoing cryptography operations, the client terminal 26 keeps a log of the number of bytes of the file/data 22 transferred from the server terminal 24. If the server terminal crashes (e.g., powers down, locks up, or otherwise becomes temporarily inoperable), the server terminal informs the client terminal, upon reconnection, of a previous transfer failure. Alternatively, the server terminal can initially transmit the total number of bytes to be transferred, with the client terminal determining if fewer than all the bytes have been received. If the user desires to engage the crash recovery function, then the client terminal transmits to the server terminal the identity of the last byte that the client terminal received. Transfer resumes from the very next bit not transferred to the client. This allows the user to transfer bulk data over an insecure channel without worrying about server crashes or time loss in the event of a server crash. Typically, this feature is used in the static secure transfer mode.

The system 20 can also be configured for progress monitoring of file/data transfer. Here, the system provides a graphical representation of the amount of information transferred, the amount of information remaining to be transferred, and the rate of transfer. The rate of transfer measurement provides an insight as to both the network's performance and the cryptography system's performance. Such a feature could be used in both the static secure transfer mode and the dynamic secure real time transfer mode.

The system 20 may be implemented on each terminal 24, 26 as a hardware module (e.g., “CryptoChip”) integrated with the terminal's existing electronics. The system may also be implemented as a software module, software/hardware module, or the like, using instructions executable by a computer or other electronic device, as stored on a computer readable medium (not shown) such as an optical disc, fixed disc, or integrated circuit. The system 20 may be implemented in different manners on different terminals, e.g., one terminal may have a hardware-based module and another a software-based module. Additionally, the system 20 can be integrated with a terminal's existing communication or data transfer software or otherwise with little modification in program flow.

In the dynamic transfer mode, the process of encryption is the same as in the static transfer mode. First, the data 22 (possibly subject to dynamic modification) is converted to binary form and encrypted to form cipher text 52. Subsequently, when a user requests a key length modification during a session, the system automatically halts and expands or contracts the LFSR's based on the new key length. A new set of primitive polynomials is generated at both the client side and the server side. Once the system is ready, encryption starts from the very next unencrypted bit. At the client side, since the key stream generators are synchronized, the same revised key stream will be used to decrypt the data.

Although the cryptography system of the present invention has been shown as carrying out data encryption at a server terminal and data decryption at a client terminal, it should be appreciated that each terminal could be configured for carrying out both encryption and decryption operations. For example, each terminal could include such functionality for both receiving and transmitting encrypted data.

Since certain changes may be made in the above-described dual-mode variable length cryptography system, without departing from the spirit and scope of the invention herein involved, it is intended that all of the subject matter of the above description or shown in the accompanying drawings shall be interpreted merely as examples illustrating the inventive concept herein and shall not be construed as limiting the invention.

We claim:

1. A method of data encryption, said method comprising the steps of:
generating a key stream based at least in part on a first private key, wherein the first private key comprises a randomized compilation of at least one dynamic system parameter of a first terminal where the first private key is generated; and
encrypting data with the key stream.

2. The method of claim 1 further comprising:
varying a length of the key stream concurrent with encrypting the data.

3. The method of claim 1 further comprising:
converting the data to binary form prior to encrypting the data with the key stream.

4. The method of claim 1 wherein:
the key stream is at least pseudo-randomly generated as an output of a plurality of interconnected linear feedback shift registers (LFSR's); and
the method further comprises automatically adjusting a length of each of the LFSR's based on a user-selected key length.

5. The method of claim 4 wherein:
the key stream is generated based at least in part on at least one primitive polynomial, said at least one primitive polynomial defining a plurality of feedback signal taps of at least one of said plurality of LFSR's; and
said at least one primitive polynomial is automatically generated based on said user-selected key length.

6. The method of claim 1 further comprising:
generating a shared secret key based on the first private key and a first public key received from a second terminal to which the encrypted data is transmitted, wherein the key stream is generated based at least in part on the shared secret key.

7. The method of claim 6 wherein:
the key stream is at least pseudo-randomly generated as an output of a plurality of interconnected linear feedback shift registers (LFSR's), wherein bit values of the shared secret key are used to seed the LFSR's prior to generation of the key stream; and
the method further comprises automatically adjusting a length of each of the LFSR's based on a user-selected key length.

8. The method of claim 1 further comprising:
generating the key stream at a second terminal to which the encrypted data is transmitted, wherein the key stream is generated based at least in part on a first public key received at the second terminal from the first terminal, said first public key being mathematically related to the first private key; and
decrypting the encrypted data with the key stream.

9. The method of claim 8 wherein the key stream is generated at the second terminal based further at least in part on a second private key, wherein the second private key comprises a randomized compilation of at least one dynamic system parameter of the second terminal.

10. The method of claim 9 further comprising:
transmitting a second public key from the second terminal to the first terminal, said second public key being mathematically related to the second private key;
generating a shared secret key at the first terminal based on the first private key and the second public key; and
generating the shared secret key at the second terminal based on the second private key and the first public key, wherein the key stream is generated at each of the first and second terminals based on the shared secret key.

11. The method of claim 10 wherein at each of the first and second terminals:
the key stream is at least pseudo-randomly generated as an output of a plurality of interconnected linear feedback shift registers (LFSR's), wherein bit values of the shared secret key are used to seed the LFSR's prior to generation of the key stream; and
the method further comprises automatically adjusting a length of each of the LFSR's based on a user-selected key length.

12. A method of data encryption, said method comprising the steps of:
encrypting data with an encryption key having a user-selected length; and
modifying the length of the encryption key concurrent with encrypting said data, according to a user selection of the modified length.

13. The method of claim 12 further comprising:
at least pseudo-randomly generating the encryption key as an output of a plurality of interconnected linear feedback shift registers (LFSR's), wherein an initial length of each of the LFSR's is based on the user-selected key length; and
subsequent to user selection of the modified key length, adjusting the length of each of the LFSR's based on the user-selected modified key length.

14. The method of claim 13 further comprising:
generating the encryption key based at least in part on at least one first primitive polynomial, said at least one first primitive polynomial defining a plurality of feedback signal taps of at least one of said plurality of LFSR's, wherein said at least one primitive polynomial is generated based on said user-selected key length; and
generating at least one second primitive polynomial according to the user-selected modified key length, wherein the encryption key is generated based at least in part on said at least one second primitive polynomial subsequent to user selection of the modified key length.

15. A method of generating a plurality of data elements, said method comprising the steps of:
generating a shared secret key at a first terminal based at least in part on a private key of the first terminal and a public key received from a second terminal; and
encrypting said plurality of data elements based on the shared secret key.

16. The method of claim 15 wherein the private key comprises a randomized compilation of at least one dynamic system parameter of the first terminal.

17. The method of claim 15 further comprising:
generating the shared secret key at the second terminal based at least in part on a public key received from the first terminal and a private key of the second terminal, wherein the first terminal public key is a function of the first terminal private key, and wherein the second terminal public key is a function of the second terminal private key; and
decrypting said plurality of encrypted data elements based on the shared secret key, said plurality of encrypted data elements being received from the first terminal.

18. The method of claim 17 wherein:
the first terminal private key comprises a randomized compilation of at least one dynamic system parameter of the first terminal; and
the second terminal private key comprises a randomized compilation of at least one dynamic system parameter of the second terminal.

19. The method of claim 18 further comprising:
generating an at least pseudo-random key stream at the first terminal based on the shared secret key, wherein the plurality of data elements are encrypted using the key stream; and
generating the key stream at the second terminal based on the shared secret key, wherein the plurality of encrypted data elements are decrypted using the key stream.

20. The method of claim 19 further comprising:
varying a bit length of the key stream concurrent with encrypting said plurality of data elements and decrypting said plurality of encrypted data elements, based on a user selection of said bit length.
